(19) United States
(12) Patent Application Publication
(10) Pub. No.: US 2008/0284160 A1
(43) Pub. Date: Nov. 20, 2008

(54) Coupling Device and a Method of Using Same

(76) Inventor: Jarl Voster, Randaberg (NO)

Correspondence Address: DORITY & MANNING, P.A., POST OFFICE BOX 1449, GREENVILLE, SC, 29602-1449, US

(21) Appl. No.: 12/094,700

(22) PCT Filed: Nov. 17, 2006
(86) PCT No.: PCT/NO06/00421

§ 371 Date: May 22, 2008

(30) Foreign Application Priority Data
Nov. 23, 2005 (NO) 20055522

(51) Int. Cl. F16L 39/00

(52) U.S. Cl. 285/124.2

(57) ABSTRACT

The present invention describes a coupling device (1) for providing at least two different connection configurations, the coupling device (1) including at least one first portion (3, 7) which is provided with a number of first coupling elements (33, 77), and at least one second portion which is provided with a number of second coupling elements (I-VIII) which are complementary to said first coupling elements (33, 77), a first connection being provided when said at least one first portion (3, 7) is in a first coupling configuration with said at least one second portion (5), at least one of said at least one first portion (3, 7) and said at least one second portion (5) being arranged to be disengaged from the corresponding at least one second portion (5) or the at least one first portion (3, 7) and selectively be rotated relative thereto to be reengaged thereafter with the corresponding at least one second portion (5) or at least one first portion (3, 7) for the provision of another coupling configuration. The invention also describes a method of using the coupling device and the use of the coupling device for the provision of two or more coupling configurations.

The present invention relates to a coupling device. More particularly it relates to a coupling device or a so-called connector which is arranged to provide two or more coupling configurations for, for example, but not limited to, electrical systems, optical systems or fluid system, or a combination of two or more thereof. The invention also relates to a method of using the coupling device.

The object of the invention is to provide a coupling device which enables the switching from a first coupling configuration into at least one second coupling configuration of an electrical system, an optical system or a fluid system, or a combination of two or more of said systems. Generally, the invention is usable wherever there is a need for a coupling device which could provide at least two, but preferably more coupling configurations for the above-mentioned systems or combinations of systems. However, the invention will be particularly useful when used in, for example but not limited to, the switching for diagnosing, testing of systems and/or collecting of measured data in connection with systems that are difficult to access, such as in the recovery of oil off-shore or in systems that are in an environment which is not suitable for, or may be harmful to, human beings. In such environments the coupling device is advantageously arranged to be remote-controlled.

From the U.S. Pat. No. 4,564,043 is known a pneumatically actuated stepping valve for automatic control of inlets and outlets for a pneumatic fluid. From a first coupling configuration into a second coupling configuration the valve according to U.S. Pat. No. 4,564,043 must be coupled through all the coupling configurations lying between said first and said second coupling configurations.

From the Norwegian patent NO 316818 B1 is known a switch device including an input conductor and a first and a second electrical output conductor and an arrangement which provides, by an axial movement of an axially movable element, a first or a second coupling configuration.

From the German patent DE 4036671 C2 is known a light switch device for use in a motor vehicle, in which there are provided, by means of rotation and axial movement of the light switch device, several different coupling configurations for the light arrangement of the motor vehicle.

There are several drawbacks connected with the above-mentioned prior art.

The valve according to U.S. Pat. No. 4,564,043 could not be used in, for example, the switching for diagnosing, testing of systems and/or acquisition of measured data. This is due to, first of all, the fact that the publication shows a valve and not a coupling device in accordance with the object of the present invention, but also that the stepping valve could be rotated in one direction only and that it, thereby, will have to run through all the intermediate steps between a first coupling configuration and a second coupling configuration. Such a run-through of the intermediate steps could harm, for example, the diagnosing, testing or measuring for which the coupling device might be used.

The switch devices known from NO316818 and DE4036671 are only arranged to provide at least two coupling configurations for electrical couplings. Thus, they are not suited for fluid-based or fibre-optic systems.

In installations on the seabed, in which cables or control systems will have to be replaced to provide necessary diagnosing and/or acquisition of measured data or changeover to backup systems, a remote-controlled underwater vehicle, a so-called ROV, is used today. However, those are very costly and time-consuming operations, in which, additionally, there is a high risk of faults arising.

The invention has as its object to remedy or at least reduce one or more drawbacks of the prior art.

The object is achieved through features as specified in the description below and in the claims that follow.

In this document any positional specifications such as “upper” and “lower”, “bottom” and “top”, “horizontal” and “vertical” or “right” and “left” refer to the position that the coupling device is in in the figures that follow.

In one aspect the present invention is constituted by a coupling device for providing at least two different coupling configurations, the coupling device including at least one first portion, which is provided with a number of first coupling elements, and at least one second portion, which is provided with a number of second coupling elements which are complementary to said first coupling elements, a first connection being provided when said first portion is in a first coupling configuration with said second portion, and at least one of said at least one first portion and said at least one second portion being arranged to be disengaged from the corresponding at least one second or at least one first portion and selectively to be rotated clockwise or anti-clockwise to any extent relative thereto to be reengaged thereafter with the corresponding at least one second or at least one first portion for the provision of a second coupling configuration which is different from said first coupling configuration. In a preferred embodiment the coupling elements are formed by standardized commercial products which have been tested and approved for the relevant fields of utilization.

In one embodiment at least one of the at least one first portion and the at least one second portion is arranged to be axially movable for engagement with and disengagement from the at least one corresponding portion.

In a preferred embodiment the at least one first portion and the at least one second portion are preferably disposed on one common, central axis, and at least one of said portions is arranged to be rotatable about said central axis. In a preferred embodiment said axial movement and rotation about the central axis are provided by means of one or more drives. The drives could be driven by means of any known drive medium such as, but not limited to, a drive medium based on electrical current or a fluid or a combination thereof.

In one embodiment at least one of the at least one first portion and the at least one second portion is arranged to be biased into engagement with the corresponding portion. In one portion such biasing is provided by means of a spring device known per se, but other biasing devices known per se could also be used.

In one embodiment the coupling elements are arranged to establish fluid connection through the coupling device. The fluid may be constituted by a liquid or a gas. Thus, the coupling device is arranged to be used in, for example, but not limited to, hydraulic and/or pneumatic systems.

In one embodiment the coupling elements are arranged to establish electrical connection through the coupling device. Thus, the electrical connection could carry current to electric devices or carry electrical control or measuring signals through the coupling device.

In one embodiment the coupling elements are arranged to establish an optical connection through the coupling device. In this embodiment the coupling device is thus arranged to be used in fibre-optic systems.

In one embodiment the coupling device is arranged to establish a combination of two or more of said fluid connection, electrical connection and/or optical connection, respectively, through the coupling device. One and the same coupling device could thus provide different combinations for electrical connections, different combinations for fluid connections and/or different combinations for optical connections.

In a preferred embodiment the coupling device is passive when a coupling configuration has been made. By passive is meant in this connection that, in a coupling configuration, the system is “locked” and does not require control current, for example, to maintain the configuration. This is in contrast to electric coupling relays of a known type.

In one embodiment at least one of the flow paths in the at least one first portion or second portion is provided with a flow-controlling device. Such an at least one flow-controlling device could be fixed or adjustable.

In what follows, is described a non-limiting exemplary embodiment of a preferred embodiment which is visualized in the accompanying drawings, in which like or corresponding parts are indicated by the same reference numerals, and in which:

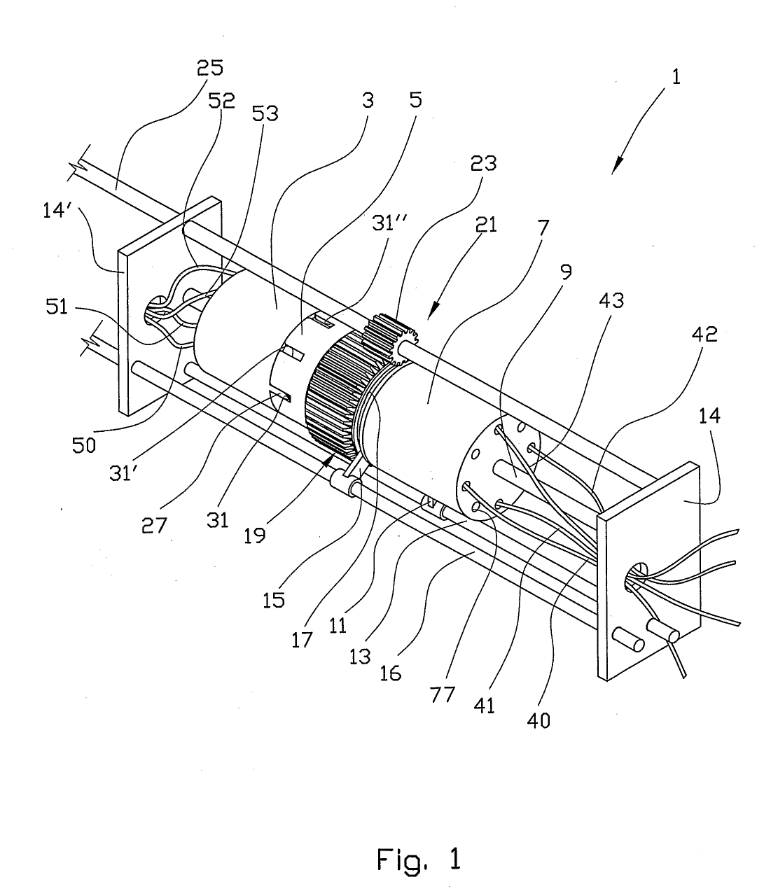

FIG. 1 shows a perspective view of a coupling device which includes, viewed from left to right, a first stationary contact housing, a second axially movable and rotatable contact housing and a third axially movable contact housing.

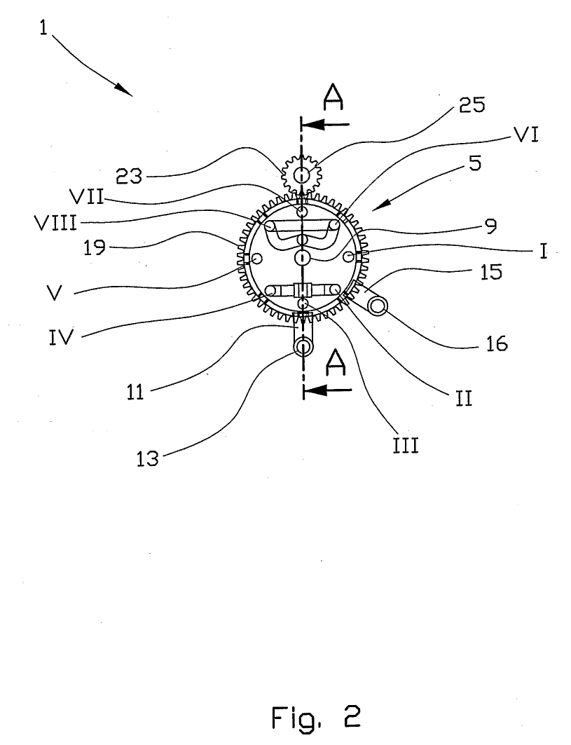

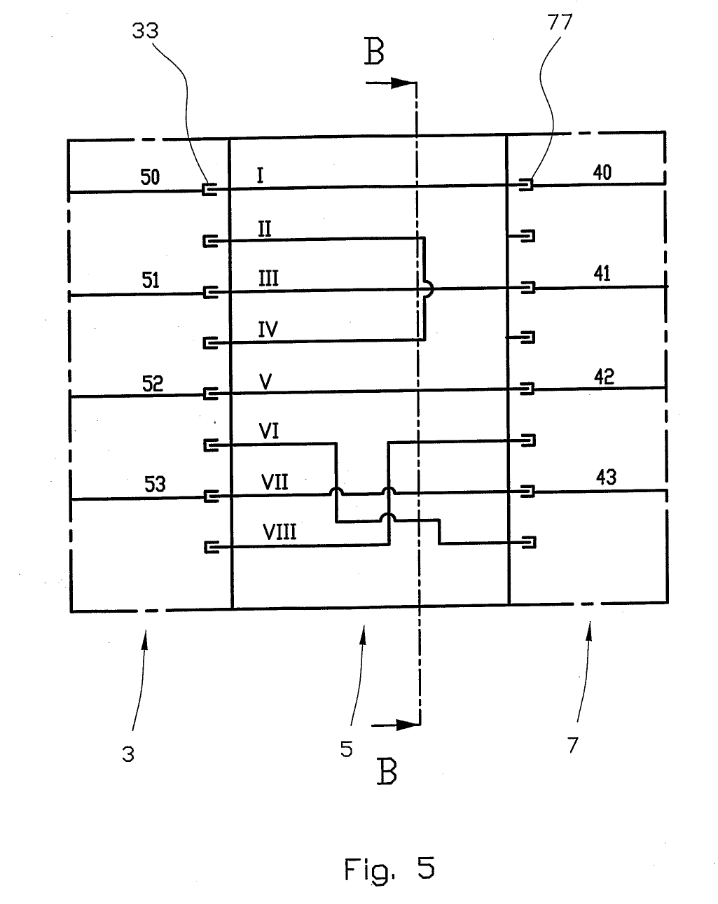

FIG. 2 shows a view through a portion of the second axially movable and rotatable contact housing of FIG. 1. The view is taken at a point indicated by the section line B-B of FIG. 5.

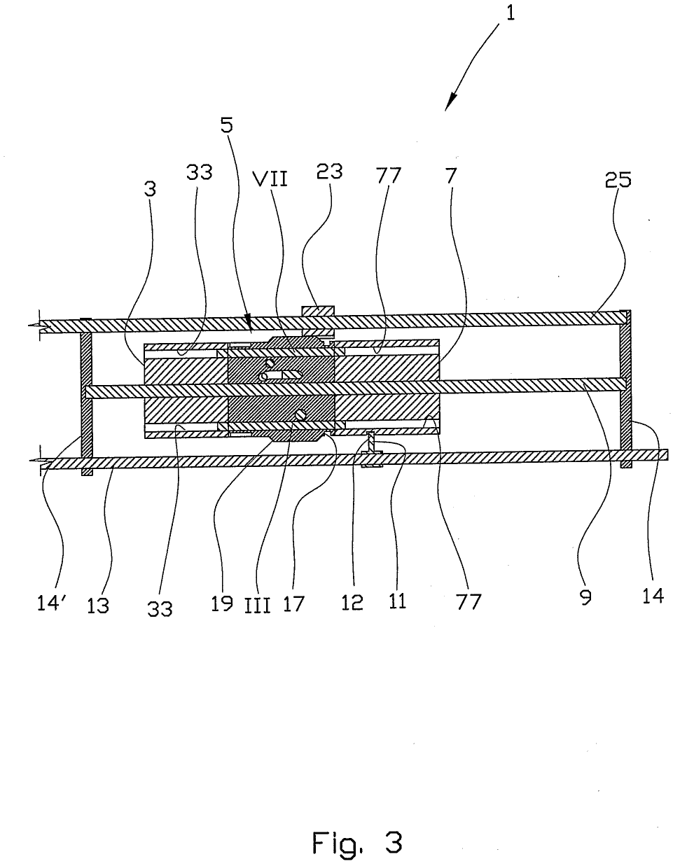

FIG. 3 shows a cross-section viewed through A-A of FIG. 2.

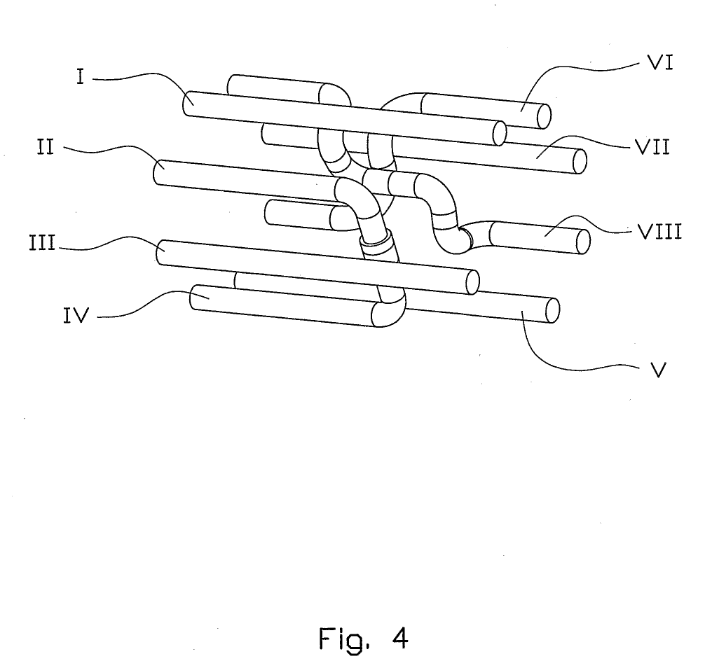

FIG. 4 shows, on a larger scale, a view of how conduits or leads extend through the second axially movable and rotatable contact housing, and the rotational positions of the conduits of FIG. 1.

FIG. 5 shows schematically the coupling configuration of FIG. 1.

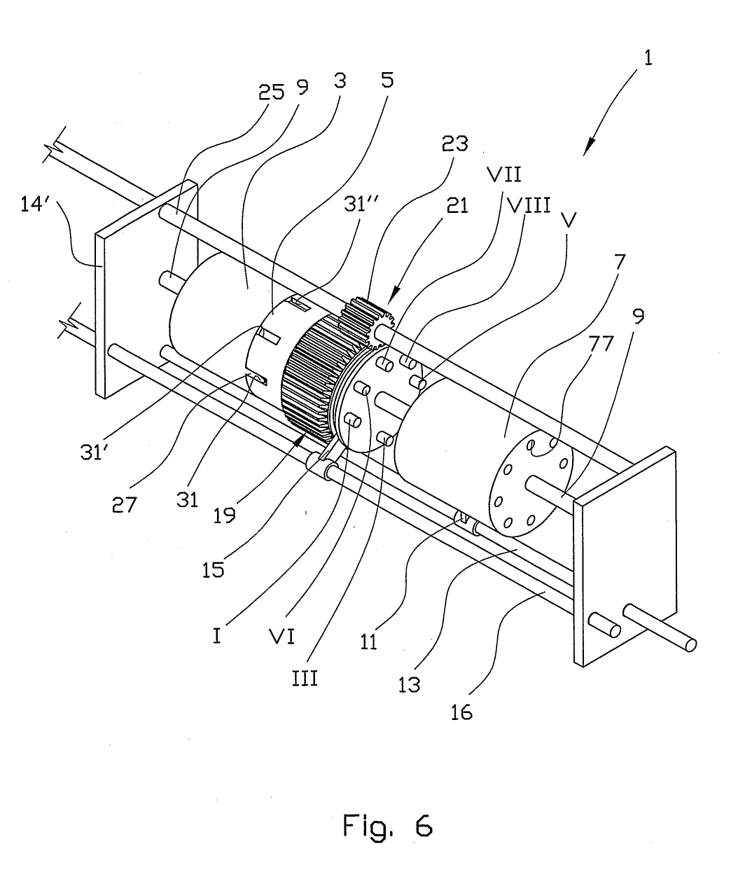

FIG. 6 shows the coupling configuration of FIG. 1, but the third axially movable contact housing has been moved out of coupling engagement from the second axially movable and rotatable contact housing.

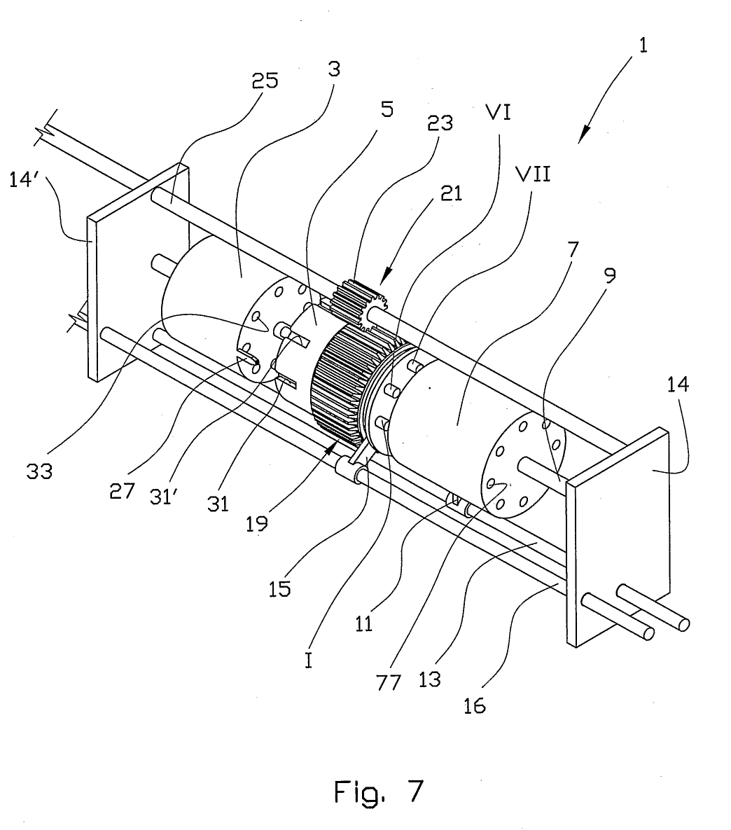

FIG. 7 shows the coupling device of FIG. 6, but the second axially movable and rotatable contact housing has additionally been pulled out of coupling engagement from the first stationary contact housing.

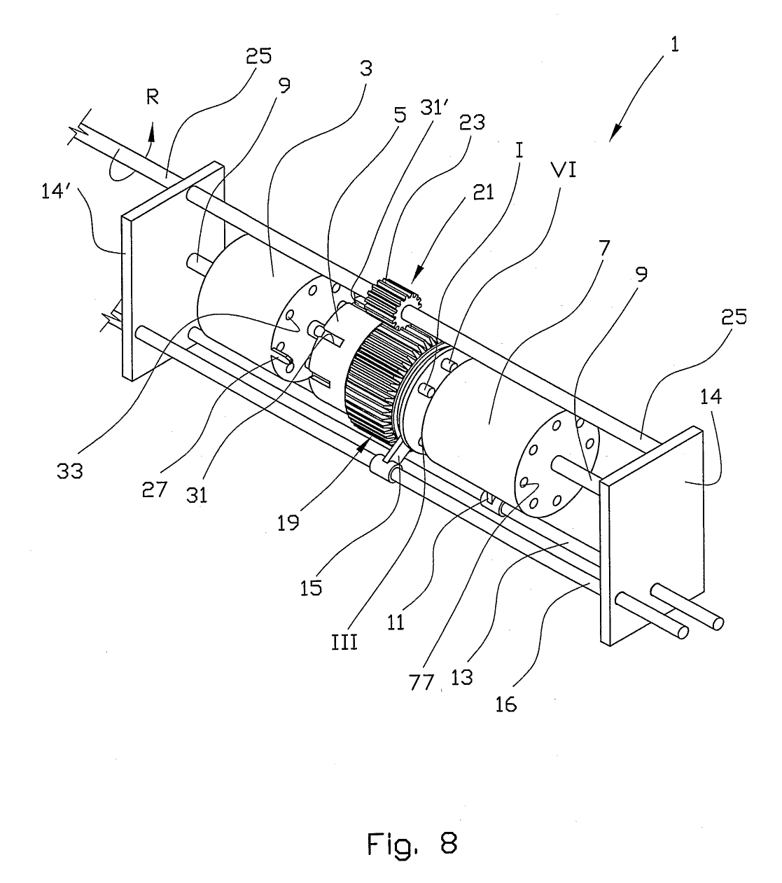

FIG. 8 shows the coupling device of FIG. 7, after the second axially movable and rotatable contact housing, by means of a rotary drive engaging a toothed surface of the second axially movable and rotatable contact housing, has rotated relative to the first stationary contact housing and the third axially movable contact housing.

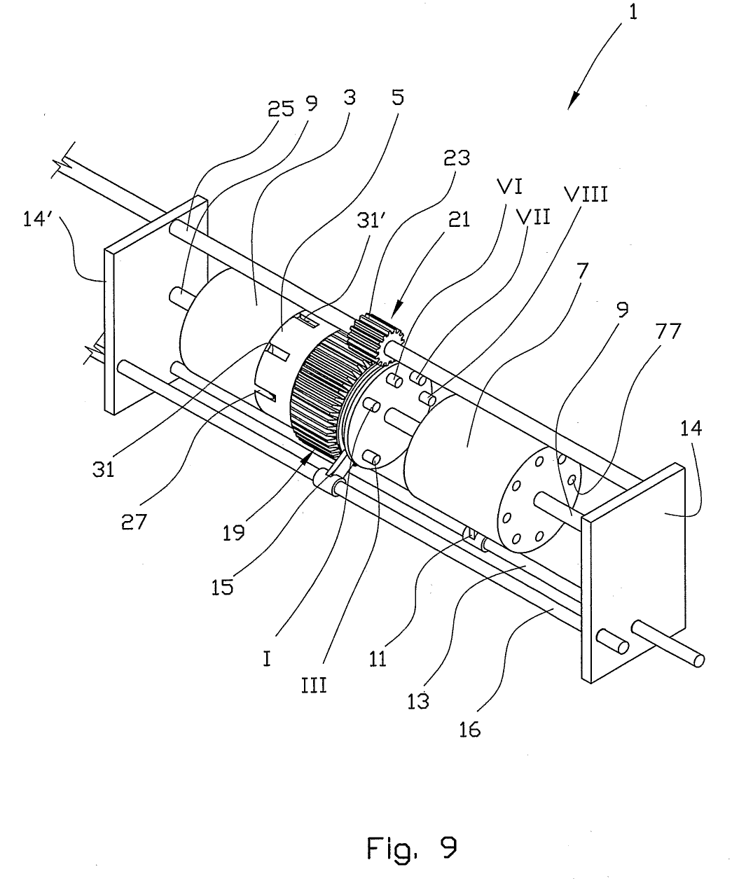

FIG. 9 shows the coupling device of FIG. 8 after the second axially movable and rotatable contact housing has been moved into coupling engagement with the first stationary contact housing.

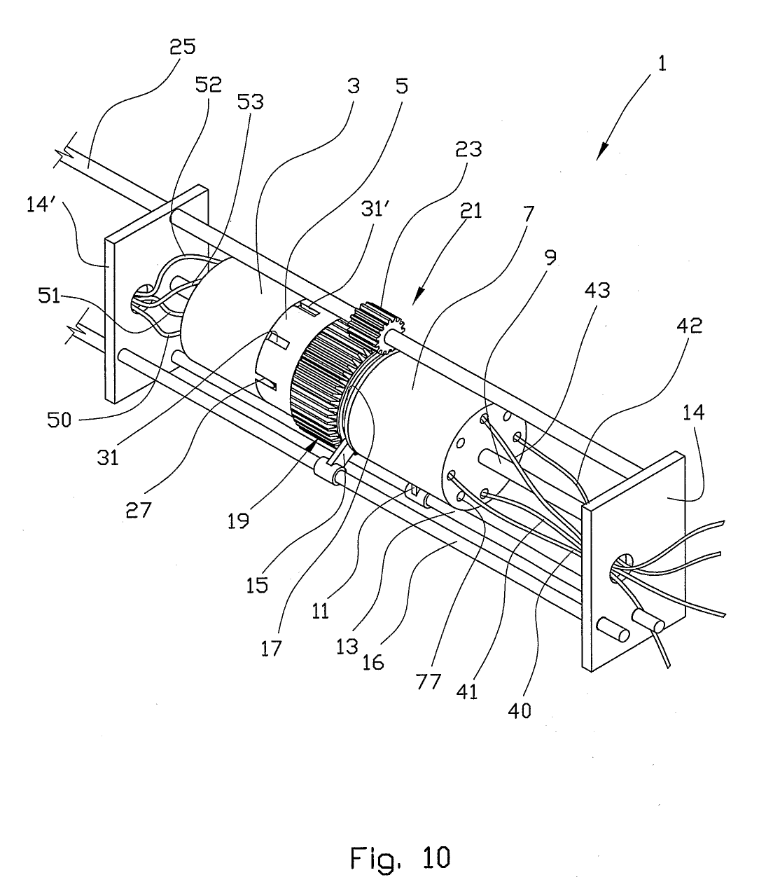

FIG. 10 shows the coupling device of FIG. 9 after the third axially movable contact housing has been moved into coupling engagement with the second axially movable and rotatable contact housing, all three contact housings thereby being interconnected.

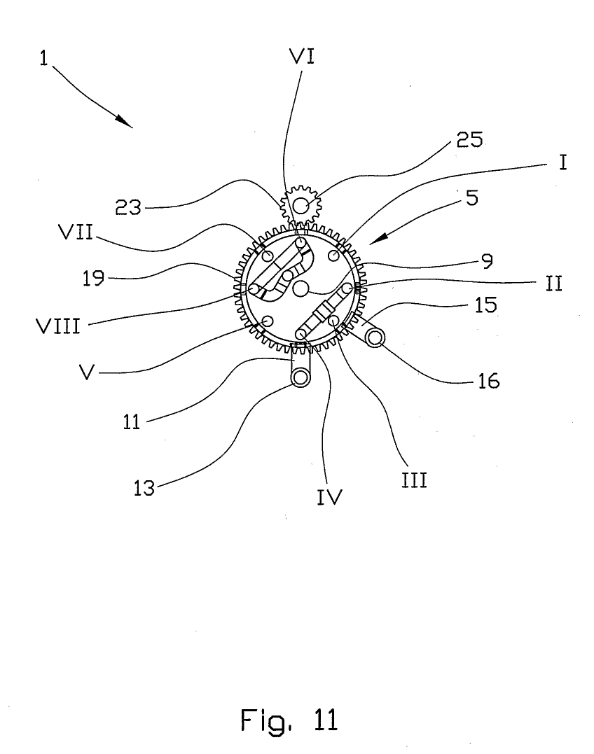

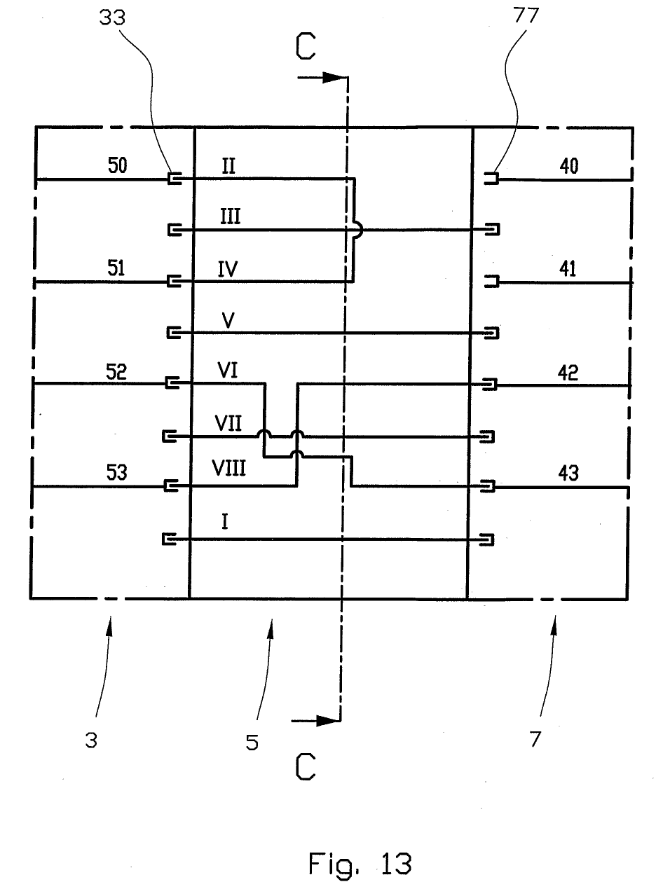

FIG. 11 shows a view through a portion of the second axially movable and rotatable contact housing of FIG. 10. The view is taken at a point indicated by the section line C-C of FIG. 13.

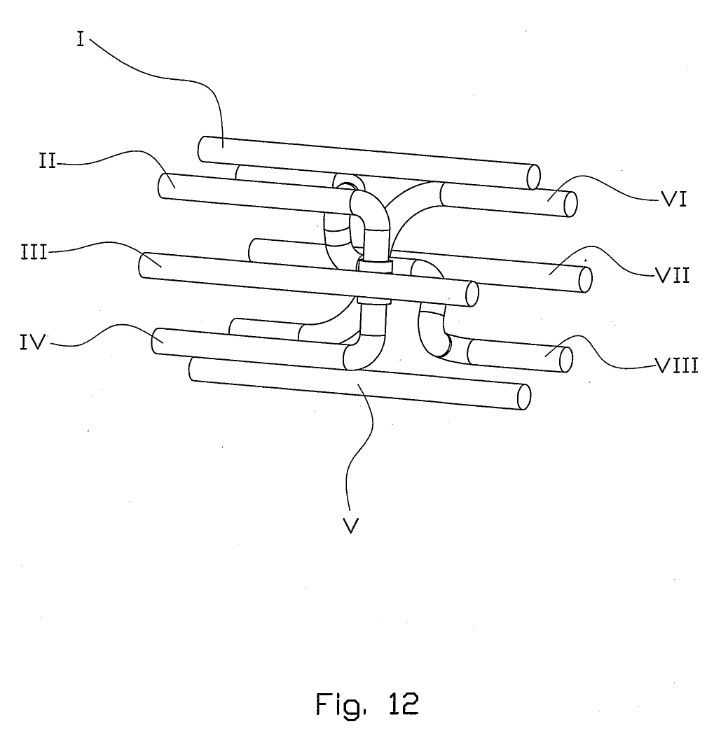

FIG. 12 shows, on a larger scale, a view of how the conduits or leads extend through the second axially movable and rotatable contact housing and the rotational positions of the conduits of FIG. 10.

FIG. 13 shows schematically the coupling configuration of FIG. 10.

In the figures the reference numeral 1 identifies a coupling device constituted by a first stationary contact housing 3, a second axially movable and rotatable contact housing 5 and a third axially movable contact housing 7. The first stationary contact housing 3 is provided with eight bores or coupling elements generally identified by the reference numeral 33. The second axially movable and rotatable contact housing 5 is provided with coupling elements I-VIII. The third axially movable contact housing 7 is provided with eight bores or coupling elements generally identified by the reference numeral 77. For clarity only one of the eight coupling elements 33 of the first contact housing 3 and one of the eight coupling elements of the third contact housing 7 are identified by reference numerals. All three contact housings 3, 5, 7 are supported by a central shaft 9.

In what follows, the first stationary contact housing is denominated as the first portion 3, the second axially movable and rotatable contact housing as a rotor or rotary portion 5 and the third axially movable contact housing as the third portion 7.

The third portion 7 is arranged to be moved axially along the central shaft 9 by means of a first guide arm 11 engaging a recess 12 (see FIG. 3) in a portion of an outer surface of the third portion 7. The first axial guide arm 11 is fixed to a first shaft 13 which is movable in its longitudinal direction by means of a first driving device known per se, but not shown. The rotary portion 5 is arranged to be movable axially along the central shaft 9 by means of a second guide arm 15 engaging an annular groove 17 provided in a portion of the outer surface of the rotary portion 5. The second axial guide arm 15 is fixed to a second shaft 16 which is movable in its longitudinal direction by means of a second driving device known per se, but not shown. In a portion of its outer surface the rotary portion 5 is provided with a toothed surface 19 meshing with a portion of a complementary drive 21. The drive 21 includes a gear 23 which is carried by a gear shaft 25 and which is connected at an end portion to a third driving device known per se, but not shown, for providing rotation of the drive 21. The first portion 3, second portion 5 and third portion 7 are all carried via the shaft 9 by two gable elements 14, 14′. The gable elements 14, 14′ also carry the shafts 13, 16, 25.

In FIG. 1 the coupling device 1 is placed in a first position. In this first position a guide pin 27 projecting from the mantle surface of the first portion 3, has been engaged in a substantially complementary guide groove 31. The guide groove 31, which forms one of a total of eight guide grooves, is placed in a portion of the mantle surface of the rotor 5. This first position provides a first coupling configuration between four leads 40-43 which extend into bores or coupling elements 77 in the third portion 7, and which are connected or in communication via the rotor 5 with one or more of the four leads 50-53 extending out through bores or coupling elements 33 in the first portion 3.

FIG. 2 shows a cross-sectional view of a portion of the rotor 5 of FIG. 1 and illustrates a first position of the rotor 5.

FIG. 3 shows a cross-section through A-A of FIG. 2 and illustrates somewhat simplified so-called male coupling elements III, VII, known per se, projecting from the rotor 5 and having been moved into the complementary bores or female coupling elements 33, 77, known per se, in the first portion 3 and third portion 7, respectively. However, it will be understood that the male and female couplings I-VIII, 33, 77 could be placed differently from what is shown, both in numbers and with respect to which portions are provided with male or female couplings. A person skilled in the art will understand that electrical leads must be connected to the shown coupling elements of a coupling device for an electrical system, and that sealing devices must be provided between the male and female coupling elements in a fluid system. Also, a person skilled in the art will understand that fibre-optic conductors must be placed in a coupling device for a fibre-optic system.

FIG. 4 shows, on a larger scale, a view of how the leads I-VIII extend through the rotary portion 5, and the rotational positions of the leads I-VIII of FIG. 1.

FIG. 5 shows a circuit diagram for the first coupling configuration of FIG. 1.

In FIGS. 6 to 10 are illustrated the different steps that are necessary to provide a second coupling configuration of the coupling device 1 in the present exemplary embodiment. For clarity, the leads 50-53, 40-43 of the coupling device 1 into, respectively, the coupling elements 33 of the first portion 3 and the coupling elements 77 of the third portion 7 and recesses of the gable elements 14, 14′, are left out in the FIGS. 6 to 9 that follow. However, it will be understood that FIGS. 6 to 9 illustrate the same coupling device 1 as that shown in the FIGS. 1 and 10.

FIG. 6 shows the coupling device 1 after the first driving device (not shown) has moved, by means of the first shaft 13 and guide arm 11, the third portion 7 along the central shaft 9 and disengaged it from the rotor 5, whereby the contact between the rotor 5 and the third portion 7 is broken.

FIG. 7 shows the coupling device 1 after the second driving device (not shown) has moved, by means of the second shaft 16 and guide arm 15, the rotor 5 along the central shaft 9 and disengaged it from the first portion 3, whereby the contacts between the rotor 5 and both the first portion 3 and the third portion 7 are broken. The gear 23 of the drive 21 is arranged to maintain its engagement in the toothed surface 19 of the rotor 5 as the rotor 5 is moved along the central shaft 9.

FIG. 8 shows the coupling device 1 after the gear 23 of the drive 21 has rotated the rotor 5 about the central shaft 9 into a second position. To ensure alignment between the male coupling elements I-VIII of the rotor 5 and the female coupling elements of the first portion 3 and the third portion 7, respectively, the rotor 5 is provided with further guide grooves 31′ placed along a portion of the external mantle surface of the rotor 5. The spacing between the guide grooves 31, 31′, 31″ is matched to the number of contact points in the coupling. In the exemplary embodiment the guide grooves 31, 31′, 31″ have an angular spacing of 45° about the external mantle surface of the rotor 5. Thus, the rotor 5 is provided with eight guide grooves even though only three are shown in the individual figure. It will be understood that the guide pin 27 projects further from the end surface of the first portion 3 than male coupling elements I-VIII project from the end surface of the second portion 5. This is to ensure that the male coupling elements I-VIII will not come into touch with the end portion of the opposite first portion 3 until the guide pin 27 guides the male coupling elements I-VIII into the female coupling elements 33 of the first portion 3. Also, it will be understood that the third portion 7 may be provided with a guide pin, for example corresponding to the guide pin 27 of the first portion 3. A person skilled in the art will understand that, in that case, the second portion 5 will have to be provided with further guide grooves corresponding to the guide grooves 31, 31′, 31″ placed in the mantle surface of the second portion 5 arranged to receive the guide pin 27.

The FIGS. 9 and 10 show the coupling device 1 after the rotor 5 has been engaged with the first portion 3, and after the third portion has been engaged with the rotor 5, respectively. The rotor 5 having a different rotational position in FIG. 10 as compared to that in FIG. 1, a new coupling configuration is established. A person skilled in the art will understand that the internal conduit paths (see for example FIGS. 4 and 12 or FIGS. 2 and 11) of the rotor 5 determine the coupling configurations that could be established. Thus, a person skilled in the art will also understand that a rotor 5, which is formed solely by through conduit paths that are parallel to the central shaft 9, and in which the number of coupling elements I-VIII corresponds to the number of coupling elements 33, 77 or bores in, respectively, the first portion 3 and the third portion 7, could not achieve different coupling configurations even if the rotor 5 is rotated about the central shaft 9. However, such a solution could be used in an alternative embodiment (not shown), in which the rotary portion 5 of the coupling device could be used as a flow controller. Such a flow controller could be a flow booster or a flow restrictor, such as, but not limited to, a filter, a nozzle or an orifice or a combination of two or more thereof. In such a flow controller at least some, but preferably all, bores in the rotary portion 5, for example, must be provided with a flow controller for fluid. By providing each of the bores of the rotary portion 5 with a fluid filter, for example, the rotary portion 5 could be considered to be a “filter holder portion”. Fluid flowing through one or more bores 33 in the first portion 3, via bores in the “filter holder portion” and further through bores 77 in the third portion 7, could be passed through new filters, as required, by rotating the rotary portion 5 or the “filter holder portion” in the same manner as the coupling device 1 described above, so that the fluid will flow through bores in the rotary portion 5 which are preferably provided with “new” or cleaned filters. It will be understood that such a solution preferably will require that there are at least twice as many bores in the rotary portion 5 as there are active fluid channels 33, 77 in, respectively, the first portion 3 and the third portion 7, and that each of the fluid channels thereof is preferably connected via new filters after a rotation of the filter portion. Correspondingly, the rotary portion 5 in alternative embodiments may be provided with orifices or nozzles which could control the flow through bores in the rotary portion 5. In a manner corresponding to that of the flow controller for fluid systems, lead paths in at least one of the portions 3, 5, 7 of the coupling device 1 for electrical systems could be provided with resistors or other electronics such as, but not limited to, filters, measuring transformers or measuring instruments. Correspondingly, in a coupling device 1 for fibre-optic systems, lead paths in at least one of the portions 3, 5, 7 could be provided with attenuators.

FIG. 11 shows a cross-sectional view of a portion of the rotor 5 of FIG. 10 and illustrates a second position of the rotor 5.

FIG. 12 shows, on a larger scale, a view of how the leads I-VIII extend through the rotary portion, and the rotary positions of the conduits I-VIII of FIG. 10.

FIG. 13 show schematically the coupling configuration of FIG. 10, a coupling configuration which is different from that shown in FIG. 5.

In one embodiment (not shown) a spiral spring is disposed around the shaft 9 between the end portion of the third portion 7 and the gable surface 14. The purpose of the spiral spring is to provide a biasing force which helps to maintain a coupling. Such biasing of the coupling device 1 provides some security should there be a failure in one or both driving devices of the shafts 13, 16, but could also maintain the coupling if it is desirable that the guide arms 11, 15 should not exert a force on, respectively, the second and third portions 5, 7 after a coupling has been established. A person skilled in the art will understand that the force that the driving devices, not shown, transmit to the second portion 5 and the third portion 7 via the guide arms 15 and 11, respectively, is greater than the biasing force of the spiral spring, not shown. Other types of pre-tensioning devices than a spiral spring could be used.

It will be understood that even though the coupling device 1 in the exemplary embodiment is shown having one stationary first portion 3, one axially movable third portion 7 and a rotor 5, the coupling device 1 may be constituted, in alternative embodiments, by just one or by several axially movable portions and by one (as shown) or more rotors. A person skilled in the art will understand that the number of possible coupling configurations will increase considerably with two or more individually rotatable rotors 5. It will also be understood that the drive 21 could be replaced by an internal arrangement, for example a so-called step motor, for the rotation of the at least one rotor 5. Also, the coupling device 1 may be supported by a fully or partially surrounding sleeve arrangement (not shown) instead of or in addition to the central supporting shaft 9.

When the coupling device 1 is used in environments in which it is necessary or desirable to protect it, the coupling device 1 could be placed within a fluid-tight and/or thermally insulated case (not shown), in which only the necessary leads penetrate through a portion of the case.

Thus, the present invention provides a novel coupling device which could switch between a desired number of coupling configurations for electrical signals, optical signals or fluids or a combination of two or more thereof. Such a combination may be achieved, for example, by the relevant conduction media being disposed in different layers in the portions of the coupling device. For example, electrical leads may be disposed in a layer placed at a relatively small radius from the centre axis of the coupling device. Fibre-optic signals may be passed, for example, through bores in a layer which is placed at larger radius from the centre axis of the coupling device, that is to say outside the layer with electrical leads. Fluid may be conveyed, for example, in an outer layer outside the layer with fibre-optic conduits.

The invention is of particularly great technical and economic utility value in situations in which there is a need to switch, in a reliable manner, between different coupling configurations in places where access to the equipment is difficult or limited, or in connection with testing of equipment, and where a large number of coupling configurations may be required for the testing to be carried out.

1. A coupling device (1) for providing at least two different coupling configurations, the coupling device (1) including at least one first portion (3, 7) which is provided with a number of first coupling elements (33, 77), and at least one second portion (5) which is provided with a number of second coupling elements (I-VIII) which are complementary to said first coupling elements (33, 77), a first connection being provided when said at least one first portion (3, 7) is in a first coupling configuration with said at least one second portion (5), characterized in that at least one of said at least one first portion (3, 7) and said at least one second portion (5) is arranged to be disengaged from the corresponding at least one second portion (5) or at least one first portion (3, 7) and selectively be rotated clockwise or anti-clockwise to any degree relative thereto, in order to be reengaged thereafter with the corresponding at least one second portion (5) or at least one first portion (3, 7) for the provision of another coupling configuration.

2-17. (canceled)
